(19) United States
(12) Patent Application Publication
(10) Pub. No.: US 2025/0334734 A1
(43) Pub. Date: Oct. 30, 2025

(54) RESIN-MOLDED ARTICLE

(71) Applicant: MORIROKU CO., LTD., Tokyo (JP)

(72) Inventor: Taiki Ito, Tokyo (JP)

(21) Appl. No.: 19/180,627

(22) Filed: Apr. 16, 2025

(30) Foreign Application Priority Data
Apr. 25, 2024 (JP) 2024-071560

(51) Int. Cl. F21V 8/00

(52) U.S. Cl. CPC G02B 6/0066; G02B 6/0075

(57) ABSTRACT

In a resin-molded article, a light guide on which light can be incident, a light emitter capable of emitting light using the light incident from the light guide, and a base material that supports the light guide and the light emitter are integrally formed. An emitting surface of the light guide and an incident surface of the light emitter are spaced apart from each other so as to face each other with an air layer interposed between the emitting surface and the incident surface.

### FIELD OF THE INVENTION

The present invention relates to a resin-molded article including a light guide.

### BACKGROUND

There is a resin-molded article including a light guide that spreads and emits light, which is incident from a light source, in a linear or planar shape. The related art relating to a resin-molded article including a light guide is disclosed in Japanese Unexamined Patent Publication No. 2019-033044.

The light guide disclosed in Japanese Unexamined Patent Publication No. 2019-033044 is adopted in a lighting device for a vehicle. The light guide of the lighting device for a vehicle includes a rod-shaped portion on which light from a light source is incident, and a plate-shaped portion including an edge disposed along the rod-shaped portion.

### SUMMARY

If the rod-shaped portion and the plate-shaped portion are integrally molded from the same material, the boundary between the rod-shaped portion and the plate-shaped portion becomes unclear, and the light incident on a proximal end of the rod-shaped portion is less likely to reach a distal end of the rod-shaped portion, and instead is immediately incident on the plate-shaped portion. Accordingly, it is difficult to uniformly illuminate up to a portion of the plate-shaped portion that is far from the light source. Therefore, Japanese Unexamined Patent Publication No. 2019-033044 discloses molding the rod-shaped portion and the plate-shaped portion using different resin materials or containing a light diffusing material in a material forming the plate-shaped portion. However, there is room for improvement from the perspective of manufacturing costs.

An object of the invention is to provide a resin-molded article capable of suppressing manufacturing costs.

The present disclosure provides a resin-molded article in which a light guide on which light can be incident and which has an emitting surface, a light emitter having an incident surface on which the light emitted from the emitting surface of the light guide can be incident, and capable of emitting light using the light incident from the incident surface, and a base material including a light guide-side support that supports the light guide and a light emitter-side support that supports the light emitter are integrally formed. The emitting surface of the light guide and the incident surface of the light emitter are spaced apart from each other so as to face each other with an air layer interposed between the emitting surface and the incident surface.

The invention can provide the resin-molded article capable of suppressing manufacturing costs.

### BRIEF DESCRIPTION OF THE DRAWINGS

FIG. 1A is a view of a resin-molded article according to an embodiment that is attached to an instrument panel of a vehicle; FIG. 1B is a cross-sectional view taken along line 1B-1B in FIG. 1A;

FIG. 2 is a perspective view of the resin-molded article of FIG. 1A;

FIG. 3 is an exploded perspective view of the resin-molded article of FIG. 2;

FIG. 4 is a view of the resin-molded article when viewed in a direction facing a front surface of a light emitter;

FIG. 5 is a view of the resin-molded article when viewed from a rear side of the light emitter;

FIG. 6A is an enlarged view of a portion surrounded by line 6A in FIG. 4; FIG. 6B is an enlarged view of a portion surrounded by line 6B in FIG. 4; FIG. 6C is an enlarged view of a portion surrounded by line 6C in FIG. 4; FIG. 6D is an enlarged view of a portion surrounded by line 6D in FIG. 4; and

FIG. 7 is an enlarged view of a portion surrounded by line 7 in FIG. 1B.

### DETAILED DESCRIPTION

### Embodiment

An embodiment will be described with reference to the accompanying drawings. In addition, in the figures, Fr, Rr, Le, Ri, Up, and Dn represent the front, the rear, the left, the right, the top or up, and the bottom or down, respectively.

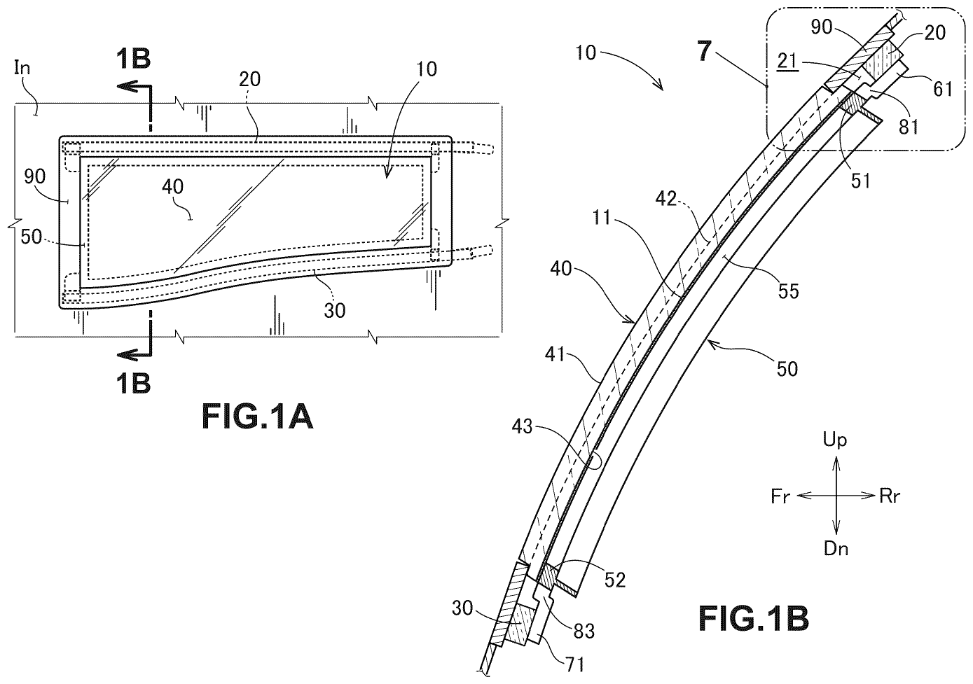

Referring to FIG. 1, hereinafter, an embodiment in which a resin-molded article according to the present disclosure is adopted as, for example, a lighting device 10 provided in an instrument panel In of a vehicle will be described.

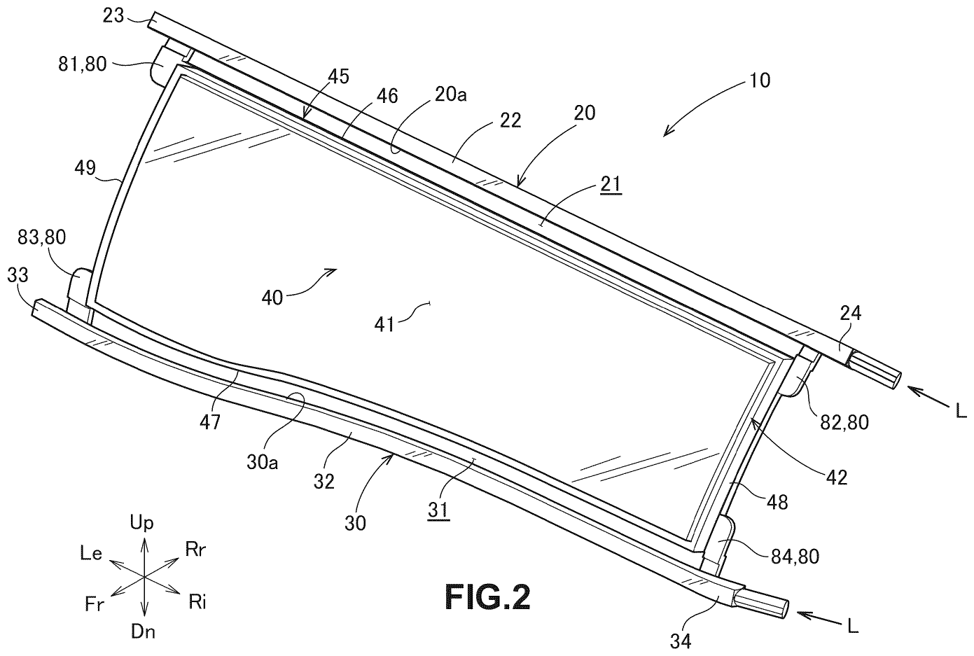

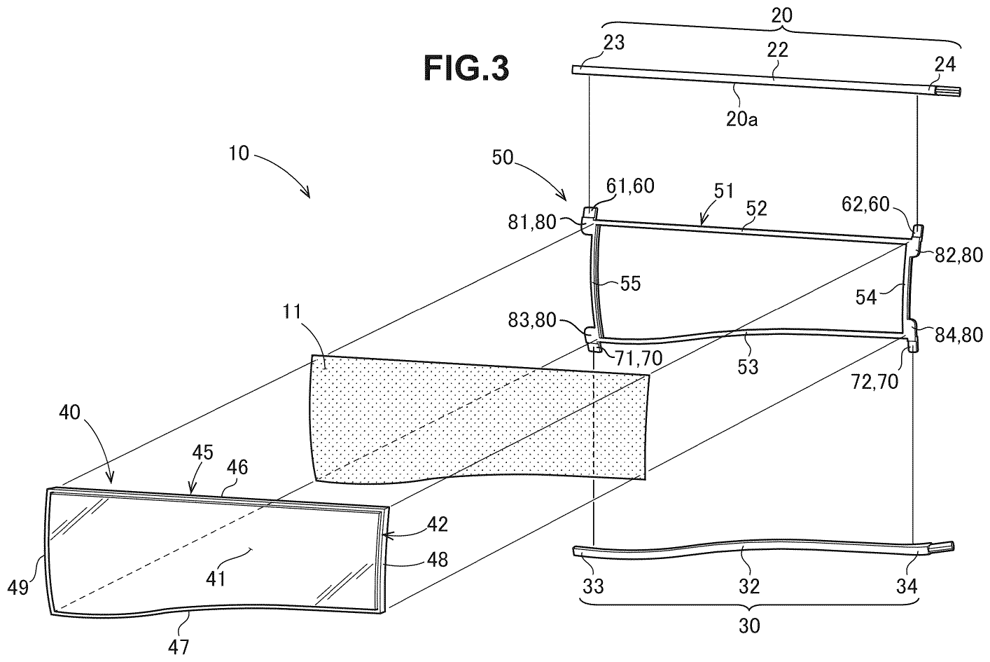

Referring to FIG. 2 and FIG. 3, the lighting device 10 includes a first light guide 20 (light guide) and a second light guide 30 on which light from a light source (see arrow L) can be incident; a light emitter 40 capable of emitting light using the light incident from the first light guide 20 and the second light guide 30; a decorative layer 11 provided on a rear surface 43 of the light emitter 40 and capable of decorating the light emitter 40; and a base material 50 that supports the light emitter 40, the first light guide 20, and the second light guide 30.

The lighting device 10 is a resin-molded article formed by heating and melting plastic resin and injecting the molten plastic resin into a mold. The first light guide 20, the second light guide 30, and the light emitter 40 are made of the same resin material; however, the material for each component can be appropriately selected, and different materials may be used. A detailed description of a method for manufacturing the lighting device 10 will be omitted.

The light emitter 40 has a plate shape, and the outer shape thereof is a substantially rectangular shape. The shape of the light emitter 40 can be changed as appropriate. A front surface 41 of the light emitter 40 is a surface that faces the inside of a passenger compartment and that is visible to occupants of the vehicle.

A side surface 45 of the light emitter 40 has a first longitudinal side surface 46 extending in a longitudinal direction (left-right direction) of the light emitter 40; a second longitudinal side surface 47 located opposite the first longitudinal side surface 46; a first lateral side surface 48 extending in a lateral direction (up-down direction) of the light emitter 40; and a second lateral side surface 49 located opposite the first lateral side surface 48.

The first longitudinal side surface 46 has a linear shape, and is also an incident surface on which light from the first light guide 20 can be incident. The second longitudinal side surface 47 has a curved shape, and is also an incident surface on which light from the second light guide 30 can be incident.

The distance between the first longitudinal side surface 46 and the second longitudinal side surface 47 gradually increases as the first longitudinal side surface 46 and the second longitudinal side surface 47 extend from the first lateral side surface 48 toward the second lateral side surface 49 (opposite side from the side on which light L from the light source is incident). Namely, the second lateral side surface 49 is longer than the first lateral side surface 48.

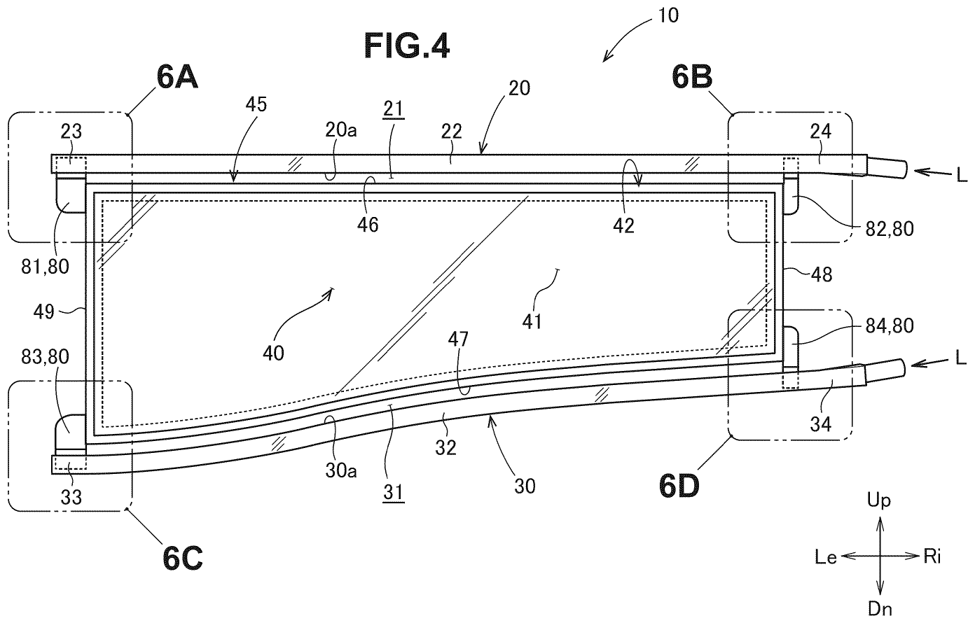

Referring to FIG. 4, the first light guide 20 is a linear member extending along the first longitudinal side surface 46 of the light emitter 40, and a cross-section thereof is a rectangular shape. Hereinafter, the side (right side) on which the light L from the light source is incident is referred to as a proximal end, and the opposite side (left side) is referred to as a distal end.

An emitting surface 20a of the first light guide 20 is spaced apart from the first longitudinal side surface 46 (incident surface) of the light emitter 40 so as to face the first longitudinal side surface 46 with a first air layer 21 interposed therebetween. A portion of the first light guide 20, which constitutes the first air layer 21, is referred to as a first body 22.

Furthermore, the first light guide 20 includes a first distal end 23 protruding from a distal end of the first body 22 beyond the second lateral side surface 49, and a first proximal end 24 protruding from a proximal end of the first body 22 beyond the first lateral side surface 48. Namely, the first light guide 20 is disposed to protrude from the first longitudinal side surface 46.

The second light guide 30 is a gently curved member extending along the second longitudinal side surface 47 of the light emitter 40, and a cross-section thereof is a rectangular shape.

An emitting surface 30a of the second light guide 30 is spaced apart from the second longitudinal side surface 47 (incident surface) of the light emitter 40 so as to face the second longitudinal side surface 47 with a second air layer 31 interposed therebetween. A portion of the second light guide 30, which constitutes the second air layer 31, is referred to as a second body 32.

Furthermore, the second light guide 30 includes a second distal end 33 protruding from a distal end of the second body 32 beyond the second lateral side surface 49, and a second proximal end 34 protruding from a proximal end of the second body 32 beyond the first lateral side surface 48. Namely, the second light guide 30 is disposed to protrude from the second longitudinal side surface 47.

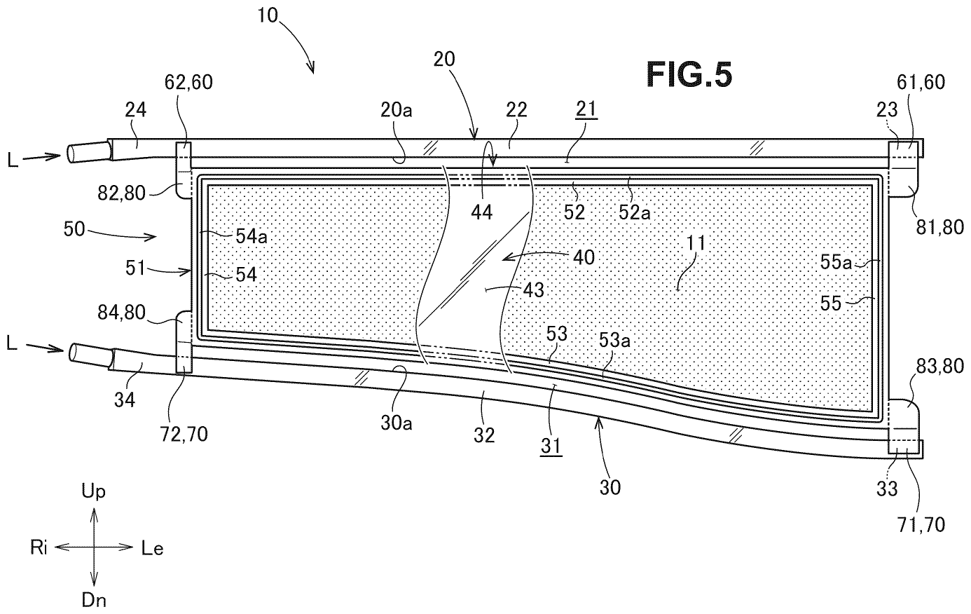

Referring to FIG. 3 and FIG. 5, the base material 50 includes a light emitter-side support 51 that supports the light emitter 40. The light emitter-side support 51 is, for example, a substantially rectangular frame-shaped portion formed along a peripheral edge 44 on a rear surface 43 side (in the embodiment, a rear surface of the decorative layer 11) of the light emitter 40.

The light emitter-side support 51 includes a first longitudinal portion 52 extending along the first longitudinal side surface 46 of the light emitter 40; a second longitudinal portion 53 extending along the second longitudinal side surface 47 of the light emitter 40; a first lateral portion 54 extending along the first lateral side surface 48 of the light emitter 40; and a second lateral portion 55 extending along the second lateral side surface 49 of the light emitter 40. The first longitudinal portion 52 to the second lateral portion 55 include ribs 52a to 55a, respectively.

Referring to FIG. 3, the decorative layer 11 is, for example, a film, and can decorate the light emitter 40 when the light emitter 40 is transparent. The light emitter-side support portion 51 and the light emitter 40 sandwich the decorative layer 11 therebetween. The decorative layer 11 may not be provided.

Referring to FIG. 3 and FIG. 4, the base material 50 includes a first light guide-side support 60 (light guide-side support) that supports the first light guide 20. The first light guide-side support 60 includes a first distal end support 61 that supports the first distal end 23 of the first light guide 20, and a first proximal end support 62 that supports the first proximal end 24 of the first light guide 20.

The base material 50 includes a second light guide-side support 70 (light guide-side support) that supports the second light guide 30. The second light guide-side support 70 includes a second distal end support 71 that supports the second distal end 33 of the second light guide 30, and a second proximal end support 72 that supports the second proximal end 34 of the second light guide 30.

Referring to FIG. 4 and FIG. 5, the base material 50 includes four connecters 80 that connect each of the light guide-side supports 60 and 70 and the light emitter-side support 51.

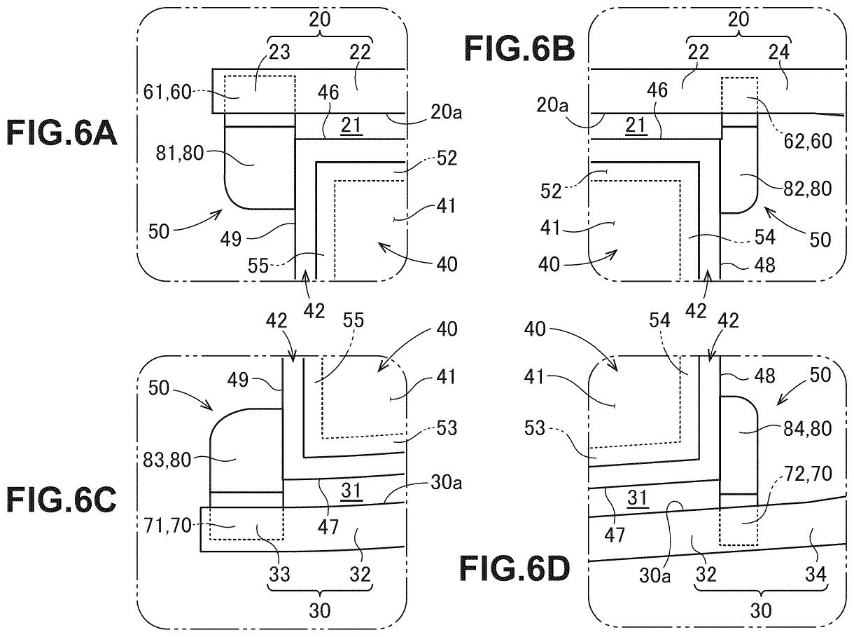

Referring to FIG. 6A, the first distal end support 61 and an upper end (an end on a first light guide 20 side) of the second lateral 55 are connected by a first distal end connecter 81. The first distal end connecter 81 is located not to overlap the first air layer 21 when viewed in a direction facing the front surface 41 of the light emitter 40.

Referring to FIG. 6B, the first proximal end support 62 and an upper end (an end on the first light guide 20 side) of the first lateral 54 are connected by a first proximal end connecter 82. The first proximal end connecter 82 is located not to overlap the first air layer 21.

Referring to FIG. 6C, the second distal end support 71 and a lower end (an end on a second light guide 30 side) of the second lateral 55 are connected by a second distal end connecter 83. The second distal end connecter 83 is located not to overlap the second air layer 31.

Referring to FIG. 6D, the second proximal end support 72 and a lower end (an end on the second light guide 30 side) of the first lateral 54 are connected by a second proximal end connecter 84. The second proximal end connecter 84 is located not to overlap the second air layer 31.

To summarize the above description, it can also be said that the first body 22 constituting the first air layer 21 and the second body 32 constituting the second air layer 31 are not supported by the base material 50.

Referring to FIG. 1A and FIG. 1B, the lighting device 10 is attached to the instrument panel In via a support 90 that supports the lighting device 10. It can also be said that the support 90 is an adapter for attaching the lighting device 10 to the instrument panel In. The support 90 is a frame-shaped that surrounds the front surface 41 of the light emitter 40 such that only the light emitter 40 is exposed, and covers the base material 50, the first light guide 20, and the second light guide 30. The lighting device 10 may be attached directly to the instrument panel In without using the support 90. In this case, attachments for attachment to the instrument panel In, such as bosses, are appropriately provided on the base material 50.

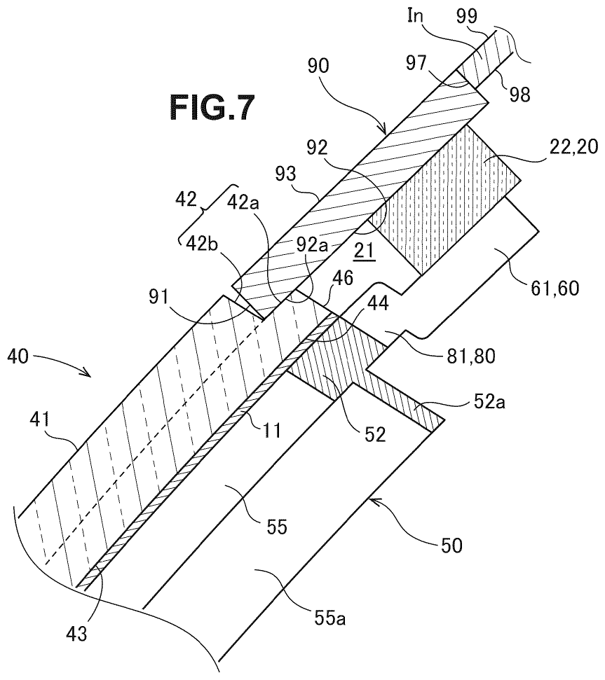

Referring to FIG. 2 and FIG. 3, the peripheral edge of the front surface 41 of the light emitter 40 includes a stepped portion 42 formed in a stepped shape. Referring to FIG. 7, the stepped portion 42 has a stepped portion bottom surface 42a facing the same direction as the front surface 41 of the light emitter 40, and a stepped portion side surface 42b facing a direction substantially perpendicular to the bottom surface 42a.

A side surface 91 on an inner peripheral side of the support 90 surrounds the stepped portion side surface 42b (it can also be said that the support 90 is a surrounding member). An edge 92a on the inner peripheral side of a rear surface 92 of the support 90 is in contact with the stepped portion bottom surface 42a. A front surface 93 of the support 90 is located on the same plane as the front surface 41 of the light emitter 40.

Referring to FIG. 2 and FIG. 3, in a first aspect, in the lighting device 10 (resin-molded article), the first light guide 20 (light guide) on which light can be incident and which has the emitting surface 20a, the light emitter 40 having the incident surface (the first longitudinal side surface 46) on which the light emitted from the emitting surface 20a of the first light guide 20 can be incident, and capable of emitting light using the light incident from the first longitudinal side surface 46, and the base material 50 including the first light guide-side support 60 that supports the first light guide 20 and the light emitter-side support 51 that supports the light emitter 40 are integrally formed. The emitting surface 20a of the first light guide 20 and the incident surface (the first longitudinal side surface 46) of the light emitter 40 are spaced apart from each other so as to face each other with the first air layer 21 interposed between the emitting surface 20a and the incident surface.

The boundary between the first light guide 20 and the light emitter 40 is made clear by interposing the first air layer 21 therebetween. Therefore, the light is repeatedly reflected inside the first light guide 20, so that the light can illuminate over a longer distance. The materials of the first light guide 20 and the light emitter 40 are not limited to being different materials, but may be the same, and no light diffusing material is also required. The first light guide 20 and the light emitter 40 are supported by the base material 50 that fixes both the first light guide 20 and the light emitter 40. The first light guide 20 and the light emitter 40 can be supported with a simple structure. As a result, the lighting device 10 in which manufacturing costs are suppressed can be provided.

In addition, when pawls, bosses, or the like are provided on the base material 50, the attachment of the lighting device 10 to the instrument panel In is also facilitated.

The shapes of the first light guide 20, the light emitter 40, and the base material 50 do not matter. In addition, instead of the first light guide 20, the second light guide 30 may be adopted.

Referring to FIG. 5, in a second aspect, in the lighting device 10 according to the first aspect, the light emitter-side support 51 has a frame shape formed along the peripheral edge 44 of the rear surface 43 of the light emitter 40.

The lighting device 10 can be made lighter compared to when the light emitter-side support 51 having a plate shape that covers the entirety of the rear surface 43 of the light emitter 40 is provided. Accordingly, light passes through the inside of the light emitter 40, and the inside of the light emitter 40 is also visible to occupants, so that the degree of design freedom when the light emitter 40 is decorated is improved.

Referring to FIG. 6A to FIG. 6D, in a third aspect, in the lighting device 10 according to the first or second aspect, the base material 50 includes the connecters 80 that connect the light guide-side supports 60 and 70 and the light emitter-side support 51, and when viewed in the direction facing the front surface 41 of the light emitter 40, the connecters 80 are located not to overlap the air layer 21.

Light entering the incident surface (the first longitudinal side surface 46) of the light emitter 40 from the emitting surface 20a of the first light guide 20 is less likely to be absorbed (attenuated) by the connecters 80 of the base material 50, so that more light can be incident on the light emitter 40 while illuminating over a long distance. The same applies to the second light guide 30.

Referring to FIG. 3, in a fourth aspect, in the lighting device 10 according to the first to third aspects, the first light guide 20 and the light emitter 40 are made of the same material. Manufacturing costs can be suppressed compared to when the first light guide 20 and the light emitter 40 are molded from different materials.

In a fifth aspect, in the lighting device 10 according to the first to fourth aspects, the decorative layer 11 (film) capable of decorating the light emitter 40 is provided on the rear surface 43 of the light emitter 40.

The decorative layer 11 can decorate the light emitter 40 by applying color or a pattern. For example, when the light emitter 40 is transparent, the inside of the light emitter 40 can be made invisible by the decorative layer 11.

Referring to FIG. 3 and FIG. 4, in a sixth aspect, in the lighting device 10 according to the fifth aspect, the light emitter-side support 51 has a frame shape formed along the peripheral edge 44 of the rear surface 43 of the light emitter 40, and the light emitter-side support 51 and the light emitter 40 sandwich the decorative layer 11 between the light emitter-side support 51 and the light emitter 40.

The decorative layer 11 can be supported using the light emitter-side support 51 of the base material 50 and the light emitter 40.

In a seventh aspect, the lighting device 10 according to the first to sixth aspects further includes the second light guide 30 in addition to the first light guide 20. The first light guide 20 and the second light guide 30 are disposed to sandwich the light emitter 40 between the first light guide 20 and the second light guide 30.

Namely, the second light guide 30 is disposed opposite the first light guide 20. Light is incident on the light emitter 40 from both sides, and the brightness of the lighting device 10 (the light emitter 40) can be increased.

In an eighth aspect, in the lighting device 10 according to the seventh aspect, the first light guide 20 and the second light guide 30 are disposed along the longitudinal direction (left-right direction) of the light emitter 40.

The brightness of the light emitter 40 can be further increased compared to when the first light guide 20 and the second light guide 30 are disposed along the first lateral side surface 48 or the second lateral side surface 49 of the light emitter 40.

Referring to FIG. 7, if the stepped portion 42 is not formed, the edge 92a on the inner peripheral side of the rear surface 92 of the support 90 overlaps the front surface 41 of the light emitter 40. Light emitted from the first light guide 20 is likely to leak from a gap where the front surface 41 and the edge 92a overlap each other.

In the embodiment, the edge of the front surface 41 of the light emitter 40 includes the stepped portion 42, which is formed in a stepped shape, around the entire periphery. The side surface 91 on the inner peripheral side of the support 90 surrounds the stepped portion side surface 42b. The edge 92a on the inner peripheral side of the rear surface 92 of the support 90 is in contact with the stepped portion bottom surface 42a. Namely, for the light emitted from the first light guide 20 to reach the passenger compartment, the light needs to pass through a gap between the side surface 91 and the stepped portion side surface 42b, in addition to passing through a gap between the edge 92a on the inner peripheral side and the stepped portion bottom surface 42a. Since the path through which the light passes to the passenger compartment has an L-shape and is long, leakage of the light emitted from the first light guide 20 can be suppressed. Furthermore, the front surface 41 of the light emitter 40 can be made flush with the front surface 93 of the support 90, and the design is improved.

When the support 90 is not provided, a configuration in which an edge 97 of a hole of the instrument panel In surrounds the stepped portion side surface 42b, the stepped portion bottom surface 42a is in contact with a rear surface 98 of the instrument panel In, and the front surface 41 of the light emitter 40 is flush with a design surface 99 of the instrument panel In may be implemented.

The invention is not limited to the embodiment as long as actions and effects of the invention are achieved. Furthermore, the elements constituting the embodiment can be combined as appropriate.

What is claimed is:

1. A resin-molded article comprising:
a light guide on which a light can be incident and that includes an emitting surface;
a light emitter including
an incident surface on which the light emitted from the emitting surface of the light guide can be incident, and capable of emitting light using the light incident from the incident surface; and
a base material including
a light guide-side support that supports the light guide and
a light emitter-side support that supports the light emitter, wherein
the light guide, the light emitter and the base material are integrally formed, and the emitting surface of the light guide and the incident surface of the light emitter are spaced apart from each other so as to face each other with an air layer interposed between the emitting surface and the incident surface.

2. The resin-molded article according to claim 1,
wherein the light emitter-side support has a frame shape formed along a peripheral edge of a rear surface of the light emitter.

3. The resin-molded article according to claim 1,
wherein the base material includes a connecter that connects the light guide-side support and the light emitter-side support, and
when viewed in a direction facing a front surface of the light emitter, the connecter is located not to overlap the air layer.

4. The resin-molded article according to claim 1,
wherein the light guide and the light emitter are made of the same material.

5. The resin-molded article according to claim 1,
wherein a decorative layer capable of decorating the light emitter is provided on a rear surface of the light emitter.

6. The resin-molded article according to claim 5,
wherein the light emitter-side support has a frame shape formed along a peripheral edge of the rear surface of the light emitter, and
the light emitter-side support and the light emitter sandwich the decorative layer between the light emitter-side support and the light emitter.

7. The resin-molded article according to claim 1, further comprising:
a second light guide in addition to the light guide,
wherein
the light guide and the second light guide are disposed to sandwich the light emitter between the light guide and the second light guide.

8. The resin-molded article according to claim 2, further comprising:
a second light guide in addition to the light guide,
wherein the light guide and the second light guide are disposed to sandwich the light emitter between the light guide and the second light guide.

9. The resin-molded article according to claim 3, further comprising:
a second light guide in addition to the light guide,
wherein the light guide and the second light guide are disposed to sandwich the light emitter between the light guide and the second light guide.

10. The resin-molded article according to claim 4, further comprising:
a second light guide in addition to the light guide,
wherein the light guide and the second light guide are disposed to sandwich the light emitter between the light guide and the second light guide.

11. The resin-molded article according to claim 5, further comprising:
a second light guide in addition to the light guide,
wherein the light guide and the second light guide are disposed to sandwich the light emitter between the light guide and the second light guide.

12. The resin-molded article according to claim 6, further comprising:
a second light guide in addition to the light guide,
wherein the light guide and the second light guide are disposed to sandwich the light emitter between the light guide and the second light guide.

13. The resin-molded article according to claim 7,
wherein the light guide and the second light guide are disposed along a longitudinal direction of the light emitter.

14. The resin-molded article according to claim 8,
wherein the light guide and the second light guide are disposed along a longitudinal direction of the light emitter.

15. The resin-molded article according to claim 9,
wherein the light guide and the second light guide are disposed along a longitudinal direction of the light emitter.

16. The resin-molded article according to claim 10,
wherein the light guide and the second light guide are disposed along a longitudinal direction of the light emitter.

17. The resin-molded article according to claim 11,
wherein the light guide and the second light guide are disposed along a longitudinal direction of the light emitter.

18. The resin-molded article according to claim 12,
wherein the light guide and the second light guide are disposed along a longitudinal direction of the light emitter.
